(19) United States
(12) Patent Application Publication
(10) Pub. No.: US 2006/0026187 A1
(43) Pub. Date: Feb. 2, 2006

(54) Apparatus, method, and program for processing data

(76) Inventors: Hisaaki Hatano, Kanagawa-Ken (JP); Chie Morita, Kanagawa-Ken (JP); Akihiko Nakase, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/080,945

(22) Filed: Mar. 16, 2005

(30) Foreign Application Priority Data
Jul. 30, 2004 (JP) 2004-224120

(51) Int. Cl. G06F 7/00

(52) U.S. Cl. 707/101

(57) ABSTRACT

There is provided a data processing apparatus including: a classification rule generation unit that generates a classification rule having a plurality of partial rules, using a set of records each record including a plurality of attribute values; a partial rule selection unit that selects a partial rule whose classification accuracy does not satisfy a predetermined standard; a record detection unit that detects records which accord with a conditional part of the selected partial rule from among the set of records; an additional attribute decision unit that decides a additional attribute to be newly added; a retrieval request unit that requests a retrieval system to retrieve attribute values of the detected records for the additional attribute; and a partial rule regeneration unit that regenerates a partial rule for replacing the selected partial rule, using the attribute values for the additional attribute retrieved by the retrieval system.

### CROSS-REFERENCE TO RELATED APPLICATIONS

This application claims the benefit of priority under 35USC § 119 to Japanese Patent Application No. 2004-224120, filed on Jul. 30, 2004, the entire contents of which are incorporated herein by reference.

### BACKGROUND OF THE INVENTION

1. Field of the Invention

The present invention relates to a data processing apparatus, a data processing method, and a data processing program.

2. Related Art

A data mining technique for discovering a rule inherent in collected and stored pieces of data, and for making a prediction using the discovered rule has been put to practical use, following development of computers. Further, the spread of the Internet enables collecting various pieces of information through a network. Development of a navigation system enables digitizing highly accurate geographic information.

The data mining technique is intended to originally analyze data (e.g., client data) collected at the expense of cost to some degree. For the purpose of collecting more and broad data at low cost, it is effective to use the Internet or the geographic information system. Although information collection using means such as the Internet or the geographic information system can expand a retrieval range as wide as a user wishes, it disadvantageously requires lots of time for retrieval. Data collected at the expense of cost and registered in a quickly accessible database will be referred to as “internal data”, and data acquired from an external portion by conducting retrieval will be referred to as “external data”, hereinafter.

Meanwhile, as one of a data mining method, there is known a classification discovery method. This method is to classify a given set of data (record) while paying attention to specific features. For example, this method discovers a rule for classifying persons into “persons susceptible to a cold” and “persons unsusceptible to a cold” by using a height, a weight, an eyesight, and a sleeping time of each person. A decision tree is known as a typical scheme for the classification discovery method. Such items as the height, the weight, the eyesight, and the sleeping time are called “attributes”, and their values such as 160 cm and 60 kg corresponding to the respective items are called “attribute values”. Data for generating the rule is given in the form of a tuple of attribute values for the attributes such as “the height, the weight, the eyesight, the sleeping time, and whether the person caught a cold recently”. The classification discovery is to designate an object-attribute (“whether the person caught a cold recently” in this example) from the attributes, and to discover a rule for predicting attribute value for the object-attribute based on the attributes other than the object-attribute. (The attribute other than the object-attribute will be referred to simply as “attribute” hereinafter.)

It is assumed herein that sufficient classification accuracy cannot be obtained by using only the height, the weight, the eyesight, and the sleeping time. In this case, the classification accuracy may be improved by adding, for example, “a temperature of a dwelling place”. If an address of each person is known, average temperatures of the dwelling place of respective persons are retrieved using the geographic information system, and the average temperatures thus retrieved can be added as new attribute values for the new attribute “temperature of a dwelling place”. In this way, by retrieving data from external portion and adding new attribute values to analysis target data, it is expected to improve an analysis performance.

According to a conventional classification discovery, a processing is carried out by selecting attributes that can classify the object-attribute at highest accuracy, in a top down manner. In order to select the attributes that can classify the object-attribute at highest accuracy, it is necessary to obtain respective effects derived from selection of the respective attributes, and to select the attribute having highest effect. In case of adding external data to generate the classification rule, it is necessary to retrieve attribute values of all pieces of analysis target data (all records) for the added attribute.

Nevertheless, it takes lots of time to retrieve data from external portion as stated above. Due to this, overall time for the classification discovery is lengthened by the time for thus retrieving the attribute values from external portion.

### SUMMARY OF THE INVENTION

According to a first aspect of the present invention, there is provided a data processing apparatus comprising: a classification rule generation unit that generates a classification rule having a plurality of partial rules, using a set of records each record including a plurality of attribute values; a partial rule selection unit that selects a partial rule whose classification accuracy does not satisfy a predetermined standard; a record detection unit that detects records which accord with a conditional part of the selected partial rule from among the set of records; an additional attribute decision unit that decides a additional attribute to be newly added; a retrieval request unit that requests a retrieval system to retrieve attribute values of the detected records for the additional attribute; and a partial rule regeneration unit that regenerates a partial rule for replacing the selected partial rule, using the attribute values for the additional attribute retrieved by the retrieval system.

According to a second aspect of the present invention, there is provided a data processing method comprising: generating a classification rule having a plurality of partial rules, using a set of records each record including a plurality of attribute values; selecting a partial rule whose classification accuracy does not satisfy a predetermined standard; detecting records which accord with a conditional part of the selected partial rule from among the set of records; deciding a additional attribute to be newly added; requesting a retrieval system to retrieve attribute values of the detected records for the additional attribute; and regenerating a partial rule for replacing the selected partial rule, using the attribute values for the additional attribute retrieved by the retrieval system.

According to a third aspect of the present invention, there is provided a data processing program for causing a computer to execute, comprising: generating a classification rule having a plurality of partial rules, using a set of records each record including a plurality of attribute values; selecting a partial rule whose classification accuracy does not satisfy a predetermined standard; detecting records which accord with a conditional part of the selected partial rule from among the set of records; deciding a additional attribute to be newly added; requesting a retrieval system to retrieve attribute values of the detected records for the additional attribute; and regenerating a partial rule for replacing the selected partial rule, using the attribute values for the additional attribute retrieved by the retrieval system.

According to a fourth aspect of the present invention, there is provided a data processing apparatus comprising: a classification rule generation unit that generates a classification rule having a plurality of partial rules, using a set of records each record including a plurality of attribute values; a partial rule selection unit that selects a partial rule whose classification accuracy does not satisfy a predetermined standard; a record detection unit that detects records which accord with a conditional part of the selected partial rule from among the set of records; an additional attribute decision unit that decides a additional attribute to be newly added; and a partial rule regeneration unit that regenerates a partial rule for replacing the selected partial rule, using attribute values for the additional attribute got from a retrieval system.

### BRIEF DESCRIPTION OF THE DRAWINGS

FIG. 1 is a block diagram that depicts a data processing apparatus according to a first embodiment of the present invention;

FIG. 2 is a flowchart that shows processing performed by the data processing apparatus shown in FIG. 1;

FIG. 3 depicts one example of internal data;

FIG. 4 depicts a decision tree generated from the internal data shown in FIG. 3;

FIG. 5 depicts a state in which external data has been added to the internal data shown in FIG. 3;

FIG. 6 depicts a state in which an alternative rule to the rule including a terminal node L1 of the decision tree shown in FIG. 4 has been regenerated using the external data shown in FIG. 5;

FIG. 7 depicts one example of a database constructed using a known method;

FIG. 8 is a flowchart that shows processing performed by a data processing apparatus according to a second embodiment of the present invention;

FIG. 9 depicts attribute values of sampled records for additional attributes;

FIG. 10 depicts attribute values of records other than the sampled records for the additional attributes;

FIGS. 11A and 11B are explanatory view for describing the second embodiment;

FIGS. 12A and 12B are explanatory view for describing the second embodiment;

FIGS. 13A and 13B are explanatory view for describing the second embodiment;

FIG. 14 is a flowchart that shows processing performed by a data processing apparatus according to a third embodiment of the present invention;

FIG. 15 depicts a database generated by a method according to the third embodiment of the present invention; and

FIG. 16 is a flowchart that shows processing performed by a data processing apparatus according to a fourth embodiment of the present invention.

### DESCRIPTION OF THE PREFERRED EMBODIMENTS

### First Embodiment

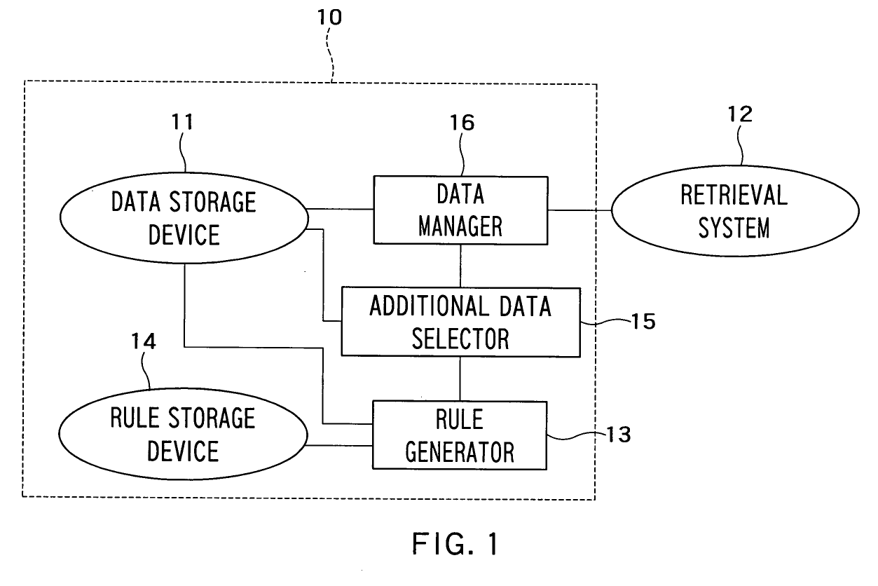

FIG. 1 is a block diagram that depicts a data processing apparatus 10 according to a first embodiment of the present invention. A data storage device 11 stores data (internal data) collected in advance for a data analysis into a database. The database includes a plurality of records, and each record includes a plurality of attribute values. Each attribute value belongs to a certain attribute. This database is quickly accessible.

A retrieval system 12 receives a retrieval request, conducts a retrieval in response to the retrieval request, and transmits a retrieval result to a requester. The retrieval system 12 is, for example, the Internet or a geographic information system. It takes lots of time to conduct a retrieval using the retrieval system 12.

A rule generator 13 generates a classification rule using the internal data stored in the data storage device 11. The rule generator 13 also discovers a rule (partial rule) having low classification accuracy from the classification rule.

A rule storage device 14 stores the classification rule generated by the rule generator 13.

An additional data selector 15 selects attributes to be newly added to improve the classification accuracy of the partial rules determined to have the low classification accuracy by the rule generator 13. The attributes to be newly added are selected from among attributes given in advance by a predetermined scheme. For example, the attributes to be newly added are selected from among the attributes given in advance by a random or by a priority order. The additional data selector 15 may receive the attributes to be newly added from a user input device. The additional data selector 15 indicates a data manager 16 to retrieve values of the selected or indicated attribute, for each of records in the database to which the partial rules determined to have the low classification accuracy are applied. Here, The records to which the partial rule are applied mean records having attribute values that accord with conditional part of the partial rule.

The data manager 16 requests the retrieval system 12 to do retrieval in response to a retrieval instruction from the additional data selector 15, and receives a retrieval result (external data). The data manager 16 adds the received external data to the internal data (database) in the data storage device 11. As a result, new attribute values are added for the records to which the partial rule determined to have the low classification accuracy are applied.

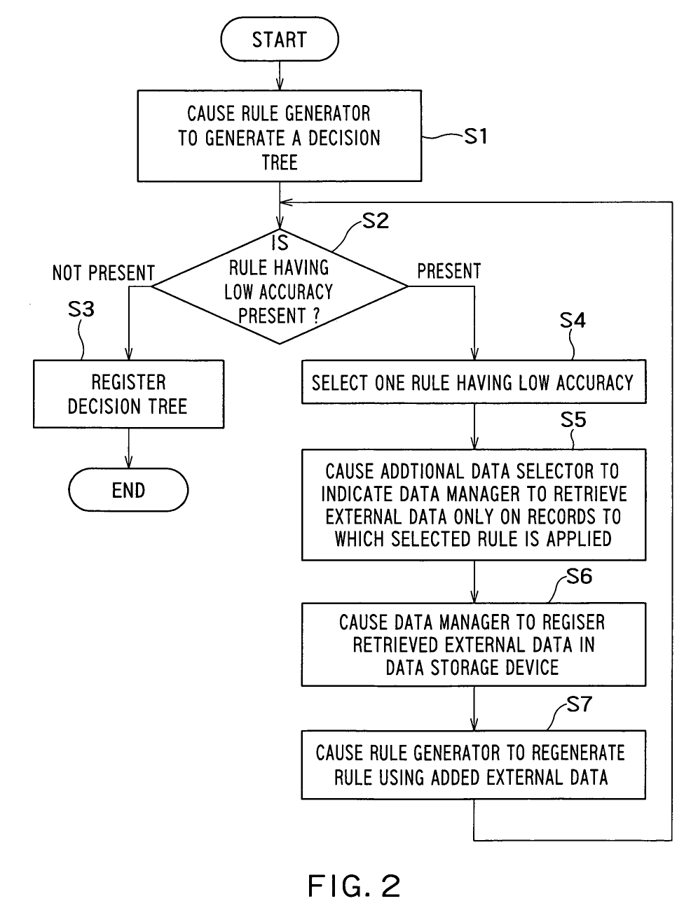

FIG. 2 is a flowchart that shows processing performed by the data processing apparatus shown in FIG. 1.

The processing performed by the data processing apparatus shown in FIG. 1 will be described in detail with reference to a specific example.

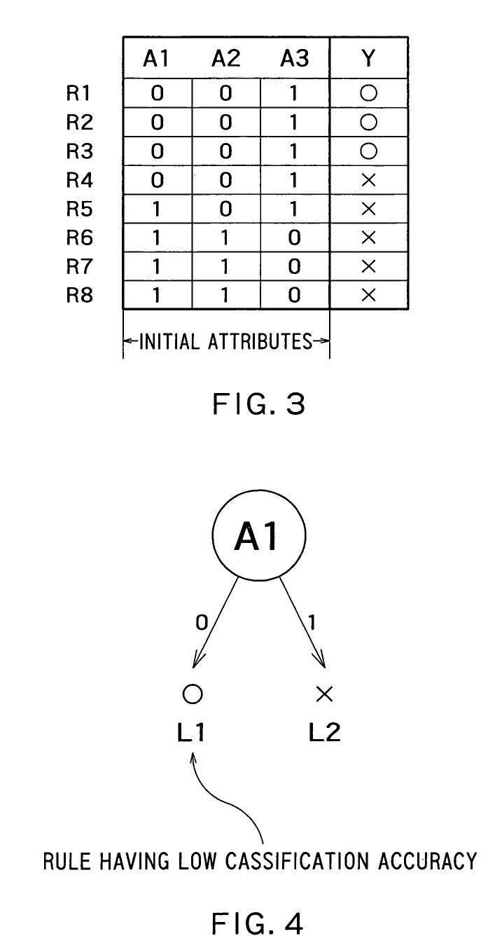

It is assumed that internal data shown in FIG. 3 is stored in the data storage device 11 in advance.

Referring to FIG. 3, A1 to A3 denote attributes and Y denotes an object-attribute (O if a person is susceptible to a cold, and x if insusceptible to a cold). The internal data includes records R1 to R8. The eight records are shown as the internal data in FIG. 3. However, the present invention is not limited to such a number of records.

The rule generator 13 generates a classification rule using the internal data shown in FIG. 3 (at a step S1). It is assumed herein that the rule generator 13 generates a decision tree as the classification rule. It is noted, however, that the present invention may include instances of generating other rule, e.g., CHAID as the classification rule.

FIG. 4 depicts the generated decision tree.

In this decision tree, only the attribute A1 is used among the attributes A1 to A3 included in the internal data. This decision tree includes two partial rules. A first partial rule is “If A1 is 0, the object-attribute is O”. A second partial rule is “If A1 is 1, the object-attribute is x”. As can be seen, each partial rule corresponds to a path from a root node to a terminal node in the decision tree. The parts “A1 is 0” and “A1 is 1” are conditional parts of the respective partial rules.

The rule generator 13 determines whether a partial rule having low classification accuracy is present in the generated decision tree (at a step S2).

If no partial rule having low classification accuracy is present (“NOT PRESENT” at the step S2), the rule generator 13 records the generated decision tree in the rule storage device 14 (at a step S3).

If a partial rule having low classification accuracy is present (“PRESENT” at the step S2), the rule generator 13 selects a partial rule having low classification accuracy by one (at a step S4).

Now, each of the records R1 to R8 in the internal data shown in FIG. 3 is applied to the decision tree shown in FIG. 4, and it is determined whether a rule having low classification accuracy is present. The records to which the rule including the terminal node L1 having the value O in FIG. 4 is applied are the records R1 to R4. Among these records, the records R1 to R3 have attribute values O for the object-attribute Y, but the record R4 has a value x for the object-attribute Y. Therefore, the classification accuracy of the rule including the terminal node L1 is 75% (=¾). The records to which the rule including the terminal node L2 having the value x in FIG. 4 is applied are the records R5 to R8. Among these records, all of the records R5 to R8 have attribute values O for the object-attribute Y. Therefore, the classification accuracy of the rule including the terminal node L2 is 100% (= 4/4). Providing that a standard classification accuracy is 90%, the classification accuracy of the rule including the terminal node L1 is low.

The additional data selector 15 selects attributes to be added to the records (R1 to R4 in this example), to which the the rule having low classification accuracy is applied, by the above selection scheme, or by inputs from the user input device. The additional data selector 15 indicates the data manager 16 to retrieve attribute values of the records to which the rule having low classification accuracy is applied, for the selected or input attributes (at a step S5).

The data manager 16 requests the retrieval system 12 to do retrieval in response to the retrieval instruction from the additional data selector 15, receives external data (attribute values for the additional attributes) retrieved by the retrieval system 12, and adds the received external data (attribute values for the additional attributes) to the internal data (database) in the data storage device 11 (at a step S6).

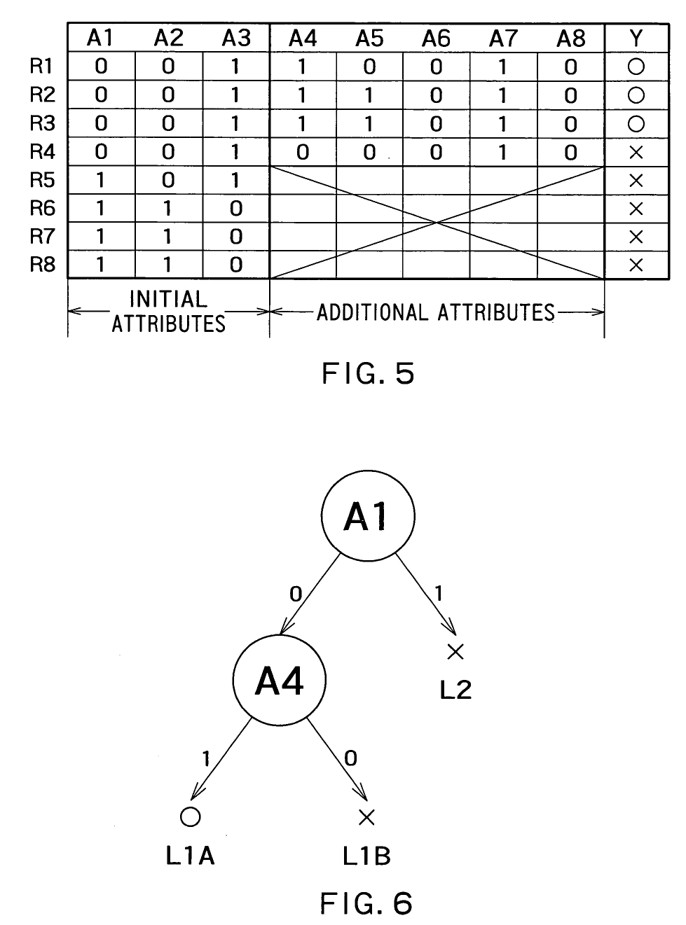

FIG. 5 depicts a state in which the external data has been added to the internal data shown in FIG. 3.

As shown in FIG. 5, attribute values of the records R1 to R4 have been added for the additional attributes A4 to A8.

The rule generator 13 regenerates an alternative rule to the rule having low classification accuracy using the added external data (at a step S7). That is to say, the rule generator 13 regenerates a rule for replacing the rule having low classification accuracy using the added external data.

FIG. 6 depicts a state in which an alternative rule to the rule including the terminal node L1 in the decision tree shown in FIG. 4 has been regenerated using the external data shown in FIG. 5. In FIG. 6, the additional attribute A4 is added to the path including the terminal node L1 shown in FIG. 4. According to this decision tree, the respective records R1 to R4 shown in FIG. 5 are accurately classified. Namely, in FIG. 5, the records R1 to R3 whose attribute values for the object-attribute are O are classified into a terminal node L1A having a value O whereas the record R4 whose attribute value for the object-attribute is x is classified into a terminal node L1B having a value x. Therefore, the classification accuracy of the decision tree is improved.

Thereafter, the rule generator 13 returns to the step S2, and repeatedly executes the steps S4 to S7 until no rule having low classification accuracy is present. If no rule having low classification accuracy is present (“NOT PRESENT” at the step S2), the rule generator 13 records the decision tree in a final state in the rule storage device 14 (at the step S3).

As can be seen, according to the first embodiment, it suffices to retrieve the attribute values of only the records to which the rule having low classification accuracy is applied, for the additional attributes. It is, therefore, possible to reduce the number of pieces of retrieval target data (the number of records) and thereby quickly generate a decision tree having high classification accuracy, as compared with the known method.

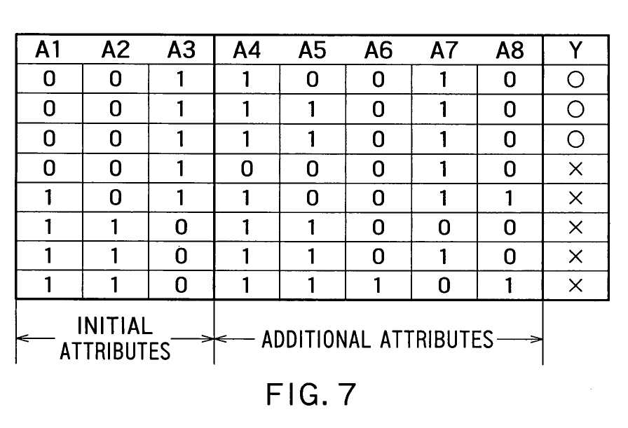

According to the known method, it is necessary to, for example, acquire the attribute values of all the records R1 to R8 shown in FIG. 3 to construct a database shown in FIG. 7, and regenerate a decision tree based on this database. Namely, the known method is required to retrieve the attribute values of even the records R5 to R8 for which the retrieval is not necessary in the first embodiment. With the known method, therefore, it takes longer time to do the retrieval, with the result that the generation of the decision tree having high classification accuracy is delayed.

According to the first embodiment, by contrast, it suffices to acquire the attribute values of only a minimum number of records. Therefore, a retrieval time is reduced and the decision tree having high classification accuracy can be generated more quickly.

### Second Embodiment

In the first embodiment, the attribute values of all the records (e.g., R1 to R4 shown in FIG. 3) to which the rule having low classification accuracy is applied are retrieved for the selected or designated attributes (e.g., A4 to A8). However, the selected or designated attributes may possibly include attributes (e.g., A5 to A8) which are not eventually used in the decision tree. If the retrieval of such attributes can be saved as much as possible, generation speed of a decision tree can be further accelerated. The present second embodiment has been achieved from this point of view. The second embodiment will be described hereinafter in detail.

A configuration of a data processing apparatus according to the second embodiment partially differs from that of the data processing apparatus according to the first embodiment with respect to the function of the additional data selector 15. The other elements of the data processing apparatus are equal to those according to the first embodiment.

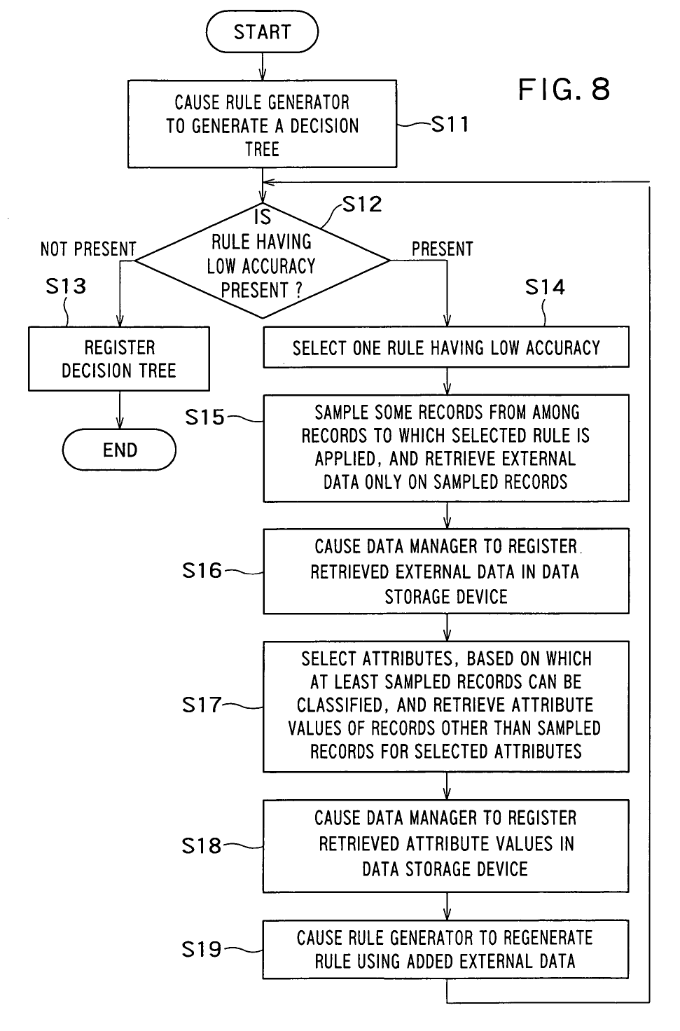

FIG. 8 is a flowchart that shows processing performed by the data processing apparatus according to this embodiment.

In FIG. 8, steps S11 to S14, S19 are equal to the first embodiment shown in FIG. 2. Therefore, the steps S15 to S18 will be mainly described herein.

The additional data selector 15 extracts records having different attribute values for the object-attribute from among the records to which the rule having low classification accuracy selected at a step S14 is applied, by sampling. In addition, the additional data selector 15 indicates the data manager 16 to retrieve attribute values of only the sampled records for the additional attributes (at the step S15). The data manager 16 request the retrieval system 12 to do retrieval in response to a retrieval instruction from the additional data selector 15, receives a retrieval result (external data), and adds the received external data to the internal data in the data storage device 11 (at the step S16).

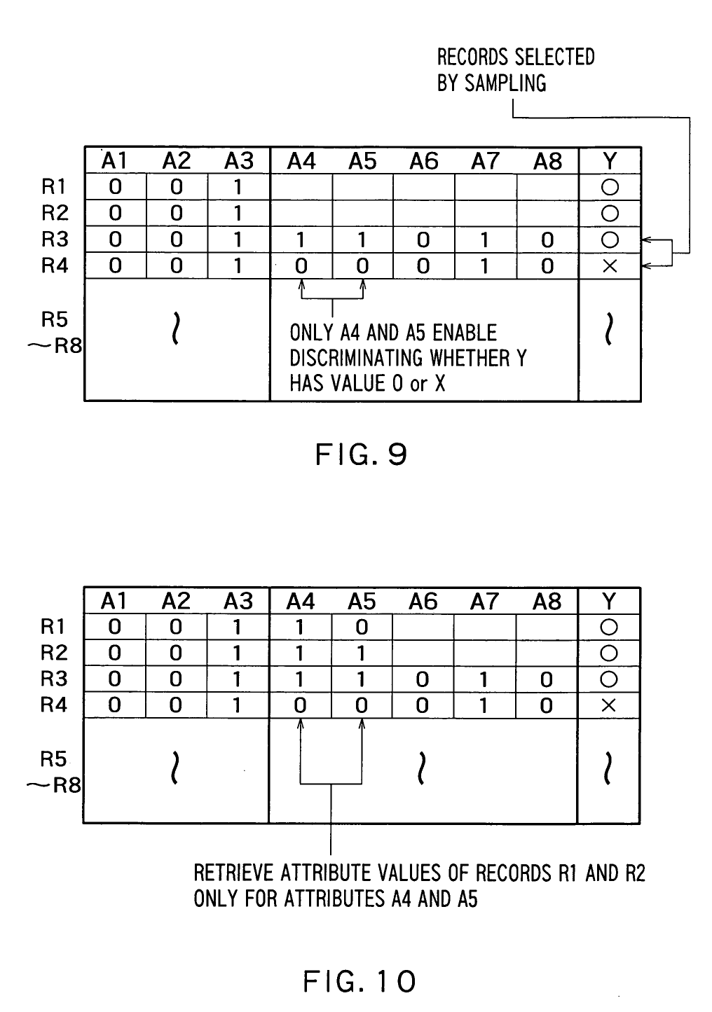

FIG. 9 depicts a state in which a certain number of (one in this embodiment) record whose attribute value for the object-attribute is O and a certain number of (one in this embodiment) record whose the attribute value for the object-attribute is x (R3 and R4 in this embodiment, respectively) have been sampled from among the records R1 to R4 to which the rule including the terminal node L1 in the decision tree shown in FIG. 4 is applied, and in which the attribute values of only the sampled records have been acquired for the additional attributes. Next, the additional data selector 15 selects a attribute or attributes, based on which at least the sampled records can be classified, from among the additional attributes (at a step S17).

In the example shown in FIG. 9, since the attributes A4 and A5 satisfy this classification condition among the additional attributes A4 to A8, the additional data selector 15 selects the attributes A4 and A5.

The additional data selector 15 indicates the data manager 16 to retrieve the attribute values for the selected attributes A4 and A5 of the records other than the sampled records among the records to which the rule having low classification accuracy is applied (at a step S17). The data manager 16 requests the retrieval system 12 to do retrieval in response to a retrieval instruction from the additional data selector 15, receives a retrieval result (external data), and adds the received retrieval result to the internal data (database) in the data storage device 11 (at a step S18).

FIG. 10 depicts a state in which the attribute values for the selected attributes A4 and A5 of the records R1 and R2 other than the sampled records R3 and R4 among the records R1 to R4 have been acquired.

Next, the rule generator 13 regenerates an alternative rule to the rule having low classification accuracy using the attribute values for the selected attributes A4 and A5 of the records to which the rule having low classification accuracy is applied (at a step S19).

A rule regenerated from the acquired attribute values of the records R1 to R4 for the attributes A4 and A5 shown in FIG. 10 is the same as A1→A4→L1A and A1→A4→L1B shown in FIG. 6. Namely, according to the second embodiment, similarly to the first embodiment, the decision tree shown in FIG. 6 is generated.

The second embodiment will be described with reference to another example.

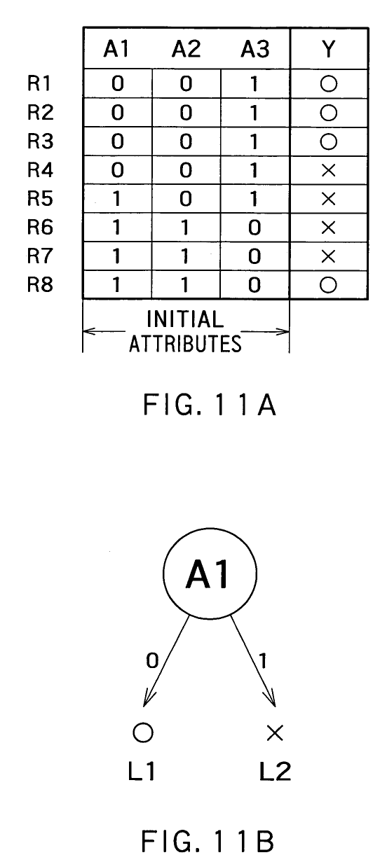

FIG. 11A depicts internal data stored in the database in the data storage device 11 in advance. FIG. 11B depicts a decision tree generated by the rule generator 13 based on the internal data shown in FIG. 11A. It is noted that the internal data shown in FIG. 11A is equal to that shown in FIG. 3 except that the attribute value of the record R8 for the object-attribute differs.

The records R1 to R4 shown in FIG. 11A are applied to the rule including the terminal node L1 shown in FIG. 11B, and the classification accuracy of the rule is 75%, similarly to the first embodiment. The records R5 to R8 shown in FIG. 11A are applied to the rule including the terminal node L2 shown in FIG. 11B, and the classification accuracy of the rule is also 75%. Providing that a standard classification accuracy is 90%, the classification accuracy of the respective rules are low.

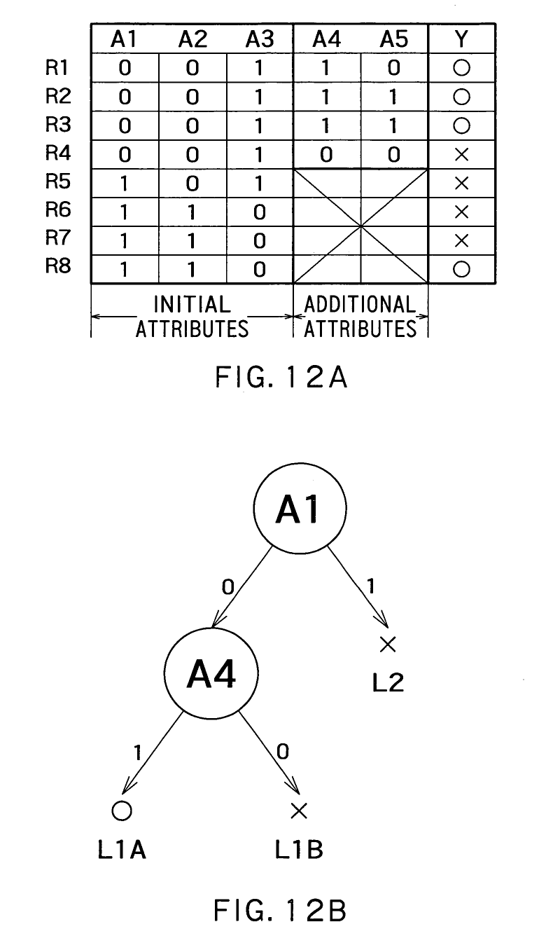

FIG. 12A depicts a state in which the attribute values of the records R1 to R4, which are applied to the rule including the terminal node L1 shown in FIG. 11B and are acquired at the steps S15 to 518 shown in FIG. 8 have been added to the internal data shown in FIG. 11A. In the example of FIG. 12A, the attribute values of the records R1 to R4 for the attributes A4 and A5 are added. FIG. 12B depicts a state in which an alternative rule to the rule including the terminal node L1 in FIG. 11B has been regenerated using the attribute values for the added attributes A4 and A5 shown in FIG. 12A at the step S19 in FIG. 8.

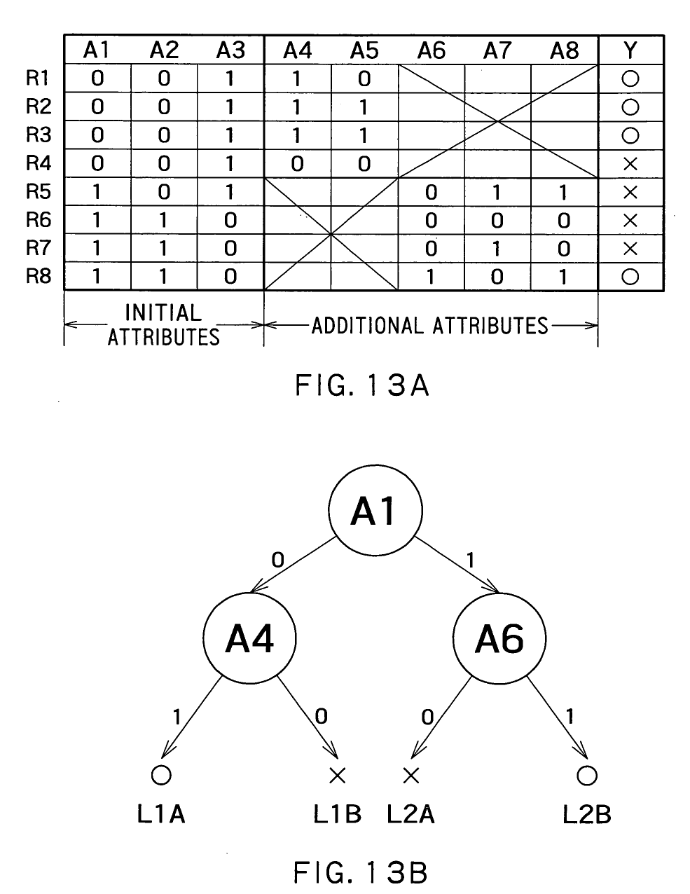

FIG. 13A depicts a state in which the attribute values of the records R5 to R8, which are applied to the rule including the terminal node L2 shown in FIG. 12B and are acquired at the steps S15 to 518 (in a second loop) shown in FIG. 8 have been added to the internal data in the database shown in FIG. 12A. In the example of FIG. 13A, the attribute values of the records R5 to R8 for the attributes A6 to A8 are added. FIG. 13B depicts a state in which an alternative rule to the rule including the terminal node L2 shown in FIG. 12B has been regenerated using the attribute values for the added attributes A6 to A8 shown in FIG. 13A at the step S19 in FIG. 8.

The classification accuracy of each rule in the decision tree shown in FIG. 13B is 100%. Therefore, the classification accuracy of the decision tree shown in FIG. 13B is improved from that of the original decision tree shown in FIG. 11B.

As can be seen, according to the second embodiment, the attributes according to which at least the sampled records can be classified are selected, and the attribute values of the records other than the sampled records are retrieved for the selected attributes. It is, therefore, possible to reduce the number of retrieval target attribute values, as compared with the first embodiment. In addition, the decision tree having high classification accuracy can be generated more quickly than the first embodiment.

### Third Embodiment

If the decision tree is partially corrected as stated in the first and the second embodiments, a size of the decision tree is often redundant. According to this third embodiment, therefore, the overall decision tree is reconstructed using only attribute values for attributes included in the decision tree generated by the first or second embodiment, and hereby, a compact decision tree is generated.

A configuration of a data processing apparatus according to the third embodiment partially differs from those of the data processing apparatuses according to the first and the second embodiments with respect to the function of the additional data selector 15. The other elements of the data processing apparatus are equal to those according to the first and the second embodiments.

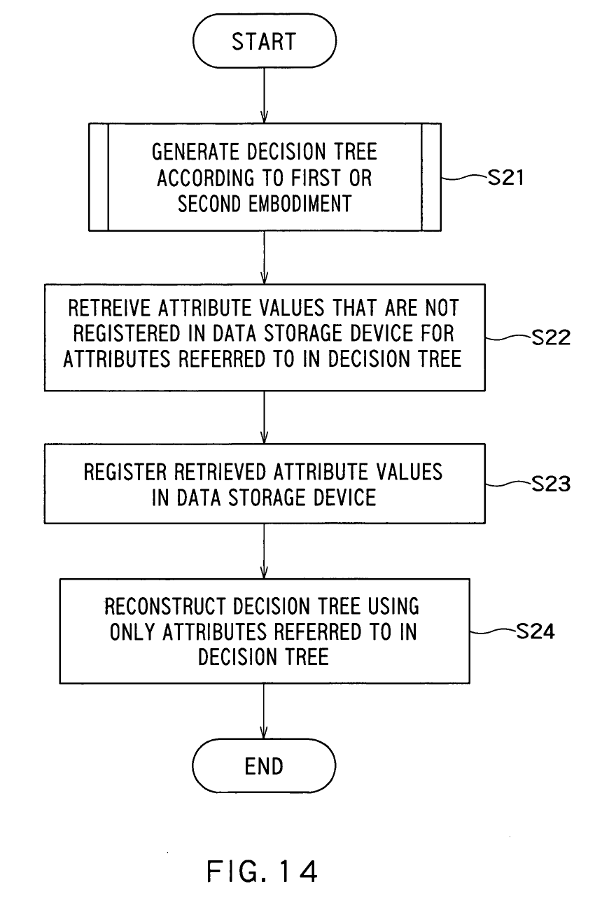

FIG. 14 is a flowchart that shows processing performed by the data processing apparatus according to the third embodiment.

First, the data processing apparatus generates a decision tree by using the first or second embodiment (at a step S21).

It is assumed herein that the decision tree is generated by the method according to the second embodiment, the decision tree generated is shown in FIG. 13B, and that the database shown in FIG. 13A is registered in the data storage device 11.

The additional data selector 15 in the data processing apparatus detects the records that do not have values for the attributes referred to in the decision tree from the internal data. In addition, the additional data selector 15 indicates the data manager 16 to retrieve attribute values of the detected records for the attributes referred to in the decision tree (at a step S22).

The attributes referred to in the decision tree shown in FIG. 13B are A1, A4, and A6. Therefore, the additional data selector 15 indicates the data manager 16 to retrieve the attribute values of only the records that do not have the attribute values for the attributes A1, A4, and A6. Specifically, the additional data selector 15 indicates the data manager 16 to retrieve the attribute values of the records R5 to R8 for the attribute A4 and the attribute values of the records R1 to R4 for the attribute A6.

The data manager 16 requests the retrieval system 12 to do retrieval in response to a retrieval instruction from the additional data selector 15, and adds the retrieval result to the internal data stored in the database in the data storage device 11 (at a step S23).

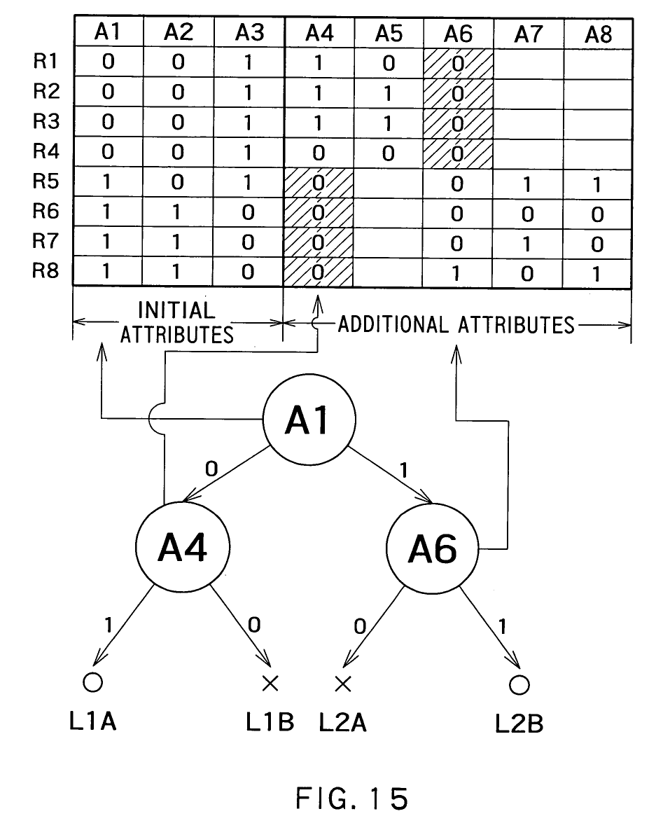

FIG. 15 depicts a state in which the attribute values are added to the internal data shown in FIG. 13A.

The rule generator 13 reconstructs a decision tree using only the attribute values for the attributes referred to in the decision tree (at a step S24).

Since the attributes referred to in the decision tree shown in FIG. 13B are A1, A4, and A6, the rule generator 13 reconstructs a decision tree using only the attributes values for the attributes A1, A4, and A6. Hereby, a compact decision tree can be sometimes constructed.

As can be seen, according to the third embodiment, the decision tree is reconstructed using only the attribute values for the attributes included in the decision tree generated according to the first or second embodiment. The compact decision tree can be, therefore, generated. Since the attributes to be referred for generating the decision tree are limited, it is, therefore, possible to generate the compact decision tree having higher classification accuracy quickly.

### Fourth Embodiment

If records are added in the data storage device 11 from one moment to next or records are updated in the data storage device 11 from one moment to next, the classification accuracy of the previously generated decision tree is sometimes deteriorated. This fourth embodiment is intended to regenerate an alternative rule to the rule having low classification accuracy in the decision tree by using the first or second embodiment if the classification accuracy of the decision tree is thus deteriorated.

The data storage device 11 according to this embodiment adds records input from external portion from one minute to next to internal data, or updates the records based on data input from external portion from one minute to next.

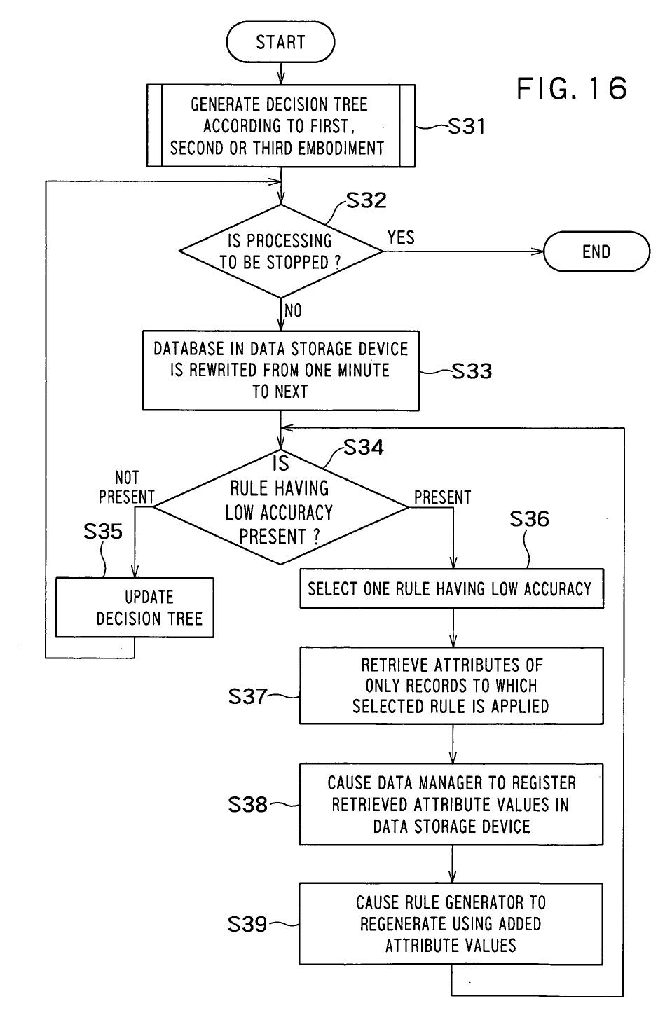

FIG. 16 is a flowchart that shows processing performed by a data processing apparatus according to the fourth embodiment.

First, this data processing apparatus generates a decision tree using the first, the second, or the third embodiment, and stores the generated decision tree in the rule storage device 14 (at a step S31).

The rule generator 13 in the data processing apparatus determines whether a instruction for stopping the present processing is input from the user input device. If the instruction is input (“YES” at a step S32), the rule generator 13 stops the processing. Specifically, the processing at a step S33 and after step S33 is stopped.

Records are collected and updated from one minute to next, and hereby the database in the data storage device 11 is rewritten from one minute to next (at a step S33).

The rule generator 13 checks whether a low classification rule is generated in the decision tree in the rule storage device 14 based on the database that is rewritten from one minute to next (at a step S34). Namely, the rule generator 13 monitors the data storage device 11, and checks whether a low classification rule is generated if a record is added and/or a record is updated.

If no rule having low classification accuracy is generated (“NOT PRESENT” at the step S34), the rule generator 13 updates the decision tree using the records in the database (at a step S35). In other words, the rule generator 13 regenerates a decision tree using all the records in the database.

If a rule having low classification accuracy is generated in the decision tree (“PRESENT” at the step S34), the rule generator 13 selects one rule having low classification accuracy (at a step S36). Thereafter, similarly to the first embodiment etc, attribute values for the additional attributes are stored in the data storage device 11 and an alternative rule to the rule having low classification accuracy is regenerated (at steps S37 to S39).

As can be seen, according to the fourth embodiment, the classification accuracy of each rule included in the decision tree is checked using the database that is updated from one minute to next. If the classification accuracy is deteriorated, an alternative rule to the rule having low classification accuracy is reconstructed using the first or second embodiment. It is, therefore, possible to maintain a decision tree having high classification accuracy without a great delay from a database update speed.

What is claimed is:

1. A data processing apparatus comprising:
a classification rule generation unit that generates a classification rule having a plurality of partial rules, using a set of records each record including a plurality of attribute values;
a partial rule selection unit that selects a partial rule whose classification accuracy does not satisfy a predetermined standard;
a record detection unit that detects records which accord with a conditional part of the selected partial rule from among the set of records;
an additional attribute decision unit that decides a additional attribute to be newly added;
a retrieval request unit that requests a retrieval system to retrieve attribute values of the detected records for the additional attribute; and
a partial rule regeneration unit that regenerates a partial rule for replacing the selected partial rule, using the attribute values for the additional attribute retrieved by the retrieval system.

2. The data processing apparatus according to claim 1, wherein the classification rule generation unit generates a decision tree as the classification rule, and paths from a root node to terminal nodes in the decision tree correspond to the plurality of partial rules.

3. The data processing apparatus according to claim 1, wherein the record detection unit detects records whose attribute values for a target attribute is different each other, from among the records that accords with the conditional part of the selected partial rule, by sampling.

4. The data processing apparatus according to claim 1, wherein the retrieval request unit detects attributes included in a classification rule replaced by the regenerated partial rule, and requests the retrieval system to retrieve attribute values for the detected attributes on records that do not have attribute values for the detected attribute, and
the classification rule generation unit regenerates a classification rule using attribute values of the set of records for the detected attributes.

5. The data processing apparatus according to claim 1, further comprising a data storage unit that stores the set of records, and that adds new records to the set of records or updates the records in the set of records,
wherein the partial rule selection unit checks whether a partial rule that does not satisfy the predetermined standard is generated in the classification rule in case where addition or update of records occurs in the data storage unit, and selects the partial rule that does not satisfy the predetermined standard in case where the partial rule that does not satisfy the predetermined standard is generated.

6. The data processing apparatus according to claim 5, further comprising a processing stop unit that stops a processing performed by the partial rule selection unit in case where a processing stop instruction is input.

7. The data processing apparatus according to claim 1,
wherein the record detection unit detects records whose attribute values for a target attribute is different each other, from among the records that accords with the conditional part of the selected partial rule, by sampling,
the additional attribute decision unit decides a plurality of additional attributes to be newly added,
the retrieval request unit requests the retrieval system to retrieve attribute values of the records detected by the sampling for the plurality of additional attributes, specifies the additional attribute based on which the records detected by the sampling are classified by predetermined accuracy among the plurality of additional attributes, based on the attribute values for the plurality of additional attributes, and requests the retrieval system to retrieve attribute values of records other than the records detected by the sampling for the specified additional attribute, among the records that accords with the conditional part of the selected partial rule, and
the partial rule regeneration unit regenerates a partial rule for replacing the selected partial rule, using the attribute values of the records that accords with the conditional part of the selected partial rule for the specified additional attribute.

8. A data processing method comprising:
generating a classification rule having a plurality of partial rules, using a set of records each record including a plurality of attribute values;
selecting a partial rule whose classification accuracy does not satisfy a predetermined standard;
detecting records which accord with a conditional part of the selected partial rule from among the set of records;
deciding a additional attribute to be newly added;
requesting a retrieval system to retrieve attribute values of the detected records for the additional attribute; and
regenerating a partial rule for replacing the selected partial rule, using the attribute values for the additional attribute retrieved by the retrieval system.

9. The data processing method according to claim 8, wherein a decision tree is generated as the classification rule, and paths from a root node to terminal nodes in the decision tree correspond to the plurality of partial rules.

10. The data processing method according to claim 8,
wherein the detecting the records includes
detecting records whose attribute values for a target attribute is different each other, from among the records that accords with the conditional part of the selected partial rule, by sampling.

11. The data processing method according to claim 8,
wherein the requesting the retrieval system includes
detecting attributes included in a classification rule replaced by the regenerated partial rule, and requesting the retrieval system to retrieve attribute values for the detected attributes on records that do not have attribute values for the detected attribute, and the generating the classification rule includes
regenerating a classification rule using attribute values of the set of records for the detected attributes.

12. The data processing method according to claim 8,
further comprising adding new records to the set of records or updating the records in the set of records,
wherein the selecting the partial rule includes
monitoring the set of records,
checking whether a partial rule that does not satisfy the predetermined standard is generated in the classification rule in case where addition or update of records occurs, and
selecting the partial rule that does not satisfy the predetermined standard in case where the partial rule that does not satisfy the predetermined standard is generated.

13. The data processing method according to claim 12, further comprising stopping the monitoring and the checking in case where a processing stop instruction is input from user.

14. The data processing method according to claim 8:
wherein the detecting the records includes;
detecting records whose attribute values for a target attribute is different each other, from among the records that accords with the conditional part of the selected partial rule, by sampling,
the deciding the additional attribute includes;
deciding a plurality of additional attributes to be newly added,
the requesting the retrieval system includes;
requesting the retrieval system to retrieve attribute values of the records detected by the sampling for the plurality of additional attributes,
specifying the additional attribute based on which the records detected by the sampling are classified by predetermined accuracy among the plurality of additional attributes, based on the attribute values for the plurality of additional attributes, and
requesting the retrieval system to retrieve attribute values of records other than the records detected by the sampling for the specified additional attribute among the records that accords with the conditional part of the selected partial rule, and the regenerating the partial rule includes;
regenerating a partial rule for replacing the selected partial rule, using the attribute values of the records that accords with the conditional part of the selected partial rule for the specified additional attribute.

15. A data processing program for causing a computer to execute:
generating a classification rule having a plurality of partial rules, using a set of records each record including a plurality of attribute values;
selecting a partial rule whose classification accuracy does not satisfy a predetermined standard;
detecting records which accord with a conditional part of the selected partial rule from among the set of records;
deciding a additional attribute to be newly added;
requesting a retrieval system to retrieve attribute values of the detected records for the additional attribute; and
regenerating a partial rule for replacing the selected partial rule, using the attribute values for the additional attribute retrieved by the retrieval system.

16. The data processing program according to claim 15, wherein a decision tree is generated as the classification rule, and paths from a root node to terminal nodes in the decision tree correspond to the plurality of partial rules.

17. The data processing program according to claim 15,
wherein the requesting the retrieval system includes
detecting attributes included in a classification rule replaced by the regenerated partial rule, and requesting the retrieval system to retrieve attribute values for the detected attributes on records that do not have attribute values for the detected attribute, and the generating the classification rule includes
regenerating a classification rule using attribute values of the set of records for the detected attributes.

18. The data processing program according to claim 15:
wherein the detecting the records includes;
detecting records whose attribute values for a target attribute is different each other, from among the records that accord with the conditional part of the selected partial rule, by sampling, the deciding the additional attribute includes;
deciding a plurality of additional attributes to be newly added,
the requesting the retrieval system includes;
requesting the retrieval system to retrieve attribute values of the records detected by the sampling for the plurality of additional attributes,
specifying the additional attribute based on which the records detected by the sampling are classified by predetermined accuracy among the plurality of additional attributes, based on the attribute values for the plurality of additional attributes, and
requesting the retrieval system to retrieve attribute values of records other than the records detected by the sampling for the specified additional attribute among the records that accords with the conditional part of the selected partial rule, and the regenerating the partial rule includes;
regenerating a partial rule for replacing the selected partial rule, using the attribute values of the records that accords with the conditional part of the selected partial rule for the specified additional attribute.

19. A data processing apparatus comprising:
a classification rule generation unit that generates a classification rule having a plurality of partial rules, using a set of records each record including a plurality of attribute values;
a partial rule selection unit that selects a partial rule whose classification accuracy does not satisfy a predetermined standard;
a record detection unit that detects records which accord with a conditional part of the selected partial rule from among the set of records;
an additional attribute decision unit that decides a additional attribute to be newly added; and
a partial rule regeneration unit that regenerates a partial rule for replacing the selected partial rule, using attribute values for the additional attribute got from a retrieval system.
